(19) United States
(12) Patent Application Publication
(10) Pub. No.: US 2005/0276644 A1
(43) Pub. Date: Dec. 15, 2005

(54) Ink jet recording apparatus

(75) Inventor: Kota Uchida, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/147,178

(22) Filed: Jun. 8, 2005

(30) Foreign Application Priority Data
Jun. 9, 2004 (JP) 2004-170878

(51) Int. Cl. B41J 11/20

(52) U.S. Cl. 400/56

(57) ABSTRACT

An ink jet recording apparatus includes a carriage for reciprocal movement while carrying recording means for effecting recording by ejecting ink; a platen for supporting the recording material at a position opposed to the recording means; a changing member for changing a distance between the recording means and the platen; a detecting member, provided on the carriage, for detecting recording positional deviation by reading a pattern recorded on a recording material by the recording means; a member to be detected movable with an operation of the changing member; and discriminating means for discriminating a distance between the recording means and the platen by detecting a state of the member to be detected by the detecting member.

### FIELD OF THE INVENTION AND RELATED ART

The present invention relates to an ink jet recording apparatus for effecting recording by ejecting ink onto a recording material by recording means.

A recording device used as a recording device such as a printer, a copying machine, a facsimile or the like, or output equipment for a combination type electronic equipment or work station including computer function, word processor function or the like, has a structure for effecting recording an image on a recording material such as a sheet of paper a thin plastic resin plate or the like, in response to image information. Such a recording device is classified on the basis of a recording system into an ink jet types a wire dot formula, a thermal formula, a laser beam formula and the like. In a recording device of a serial type using a serial scanning system, wherein main-scanning operations are repeated in a direction crossing with a feeding direction (sub-scan direction) of the recording material, one line of the image is recorded by the recording means carried on a carriage which moves along the recording material, and thereafter, the sheet is fed by a predetermined distance, and then, the image of the next line is recorded. By repeating such operations, the image is recorded on the entirety of the recording material.

Among such said recording devices, an ink jet recording apparatus effects the recording by ejecting ink onto the recording material from recording means (recording head). The ink jet recording apparatus is advantageous in the easiness of downsizing of the recording means, and in that images can be recorded at a high speed with high precision, and in addition, the recording is possible on plain paper which has not been subjected to a special process. Moreover, the running cost is low, and the noise is low since it is a non-impact type printer, and it is easy to recording color images using multi-color inks.

Particularly, recording means which ejects the ink using thermal energy can be manufactured through a semiconductor manufacturing process by forming electrothermal transducers, electrodes, liquid passages and the like on a substrate, and therefore, the ejection outlets can be easily manufactured with high density, thus accomplishing a further downsizing. Recently, the demands for the materials of the recording material become wide. For example, the recording material may be normal sheet of paper, a resin material thin plate (OHP or the like), a thin paper sheet, processed paper (sheets having punch holes for filing, paper having perforations, paper having various shapes or the like), or textile, metal or the like.

In order to form clear and high quality recording by the ink jet recording apparatus, it is very important to stably maintain a constant distance between the recording material and the recording means. The recording material may be relatively thin as in plain paper, OHP sheet or may be thick as in an envelope, plastic resin material plate or the like. The thickness of the thick recording material may exceeds 1 mm including warping. Since the distance between the recording material and the recording means is normally set approx. 1 mm, the user is required to manipulate a lever or the like to increase the distance between the recording means and the recording material (platen) upon the recording on thick recording material. The change of the gap between the recording means and the platen (recording material) is called here “head-platen distance switching”

As regards the head-platen distance switching, there are various methods for detecting whether the head-platen distance is for a thin recording material or for a thickness recording material. Japanese Laid-open Patent Application 2002-356036 discloses a method in which a position of a switching lever for moving the recording means is detected by a contact type sensor. Japanese Laid-open Patent Application 2002-96528 discloses a method in which the height of the carriage carrying the recording means is changed by a switching lever, and the change is detected. Japanese Laid-open Patent Application Hei 5-50673 discloses a method in which a platen is vertically moved by an eccentric cam, and the position of the platen is detected.

Recently, again, the sizes of the ink droplets ejected onto the recording material is reduced, and the density of the ejection nozzles is increased, wherein the ink ejection timing from an ejection outlet array (nozzle array) of the recording means is finely adjusted so as to reduce deterioration of the recording quality attributable to deviation of the recording position. As a method, Japanese Laid-open Patent Application 2002-326346 discloses that predetermined pattern is printed; and the printed pattern is read by an optical sensor or the like; an adjustment value is calculated from the read value; and the ink ejection timing during recording is adjusted on the basis of the calculated adjustment value.

### SUMMARY OF THE INVENTION

Recently, again, the main assembly of the apparatus of the ink jet recording apparatus is further downsized, and is made thinner with the result of difficulty in providing in an inexpensive manner the head-platen distance switching mechanism and/or detecting means for the head-platen distance switching to accomplish change of the head-platen distance which is the distance between the recording means and the recording material or platen.

Accordingly, it is a principal object of the present invention to provide an ink jet recording apparatus wherein the use is made with a known recording positional deviation correcting means (registration adjustment sensor or the like) to detect the head-platen distance, so that it is not necessary to add an addicted sensor, and the change of the head-platen distance can be detected with a small and inexpensive structure.

According to an aspect of the present invention, there is provided an ink jet recording apparatus comprising a carriage for reciprocal movement while carrying recording means for effecting recording by ejecting ink; a platen for supporting the recording material at a position opposed to the recording means; a changing member for changing a distance between the recording means and the platen; a detecting member, provided on the carriage, for detecting recording positional deviation by reading a pattern recorded on a recording material by the recording means; a member to be detected movable with an operation of the changing member; and discriminating means for discriminating a distance between the recording means and the platen by detecting a state of the member to be detected by the detecting member.

These and other objects, features and advantages of the present invention will become more apparent upon a consideration of the following description of the preferred embodiments of the present invention taken in conjunction with the accompanying drawings.

### BRIEF DESCRIPTION OF THE DRAWINGS

FIG. 1 is a schematic perspective view of an outer appearance of an ink jet recording apparatus according to an embodiment of the present invention.

FIG. 2 is a schematic perspective view of an inside structure of an ink jet recording apparatus according to an embodiment of the present invention.

FIG. 3 is a schematic sectional side view illustrating a state of a head-platen distance switching mechanism when the recording is effected on a thin paper such as plain paper, in an ink jet recording apparatus according to an embodiment of the present invention.

FIG. 4 is a schematic front view of a left (as seen from the front side) part of the head-platen distance switching mechanism used in the apparatus of FIG. 3.

FIG. 5 is a schematic sectional side view of a state of the head-platen distance switching mechanism when the recording is effected on thick paper such as an envelope.

FIG. 6 is a schematic front view of a left (as seen from the front side) part of the head-platen distance switching mechanism used in the apparatus of FIG. 5.

FIG. 7 is a schematic top plan view as seen from above the platen when the recording is effected on plain paper, in an ink jet recording apparatus according to an embodiment of the present invention.

FIG. 8 is a schematic top plan view of a structure of a lower side by omitting the platen from FIG. 7.

FIG. 9 is a schematic top plan view as seen from above the platen when the recording is effected on a thick sheet, according to an embodiment of the present invention.

FIG. 10 is a schematic top plan view of a structure of a lower side by omitting the platen from FIG. 9.

### DESCRIPTION OF THE PREFERRED EMBODIMENTS

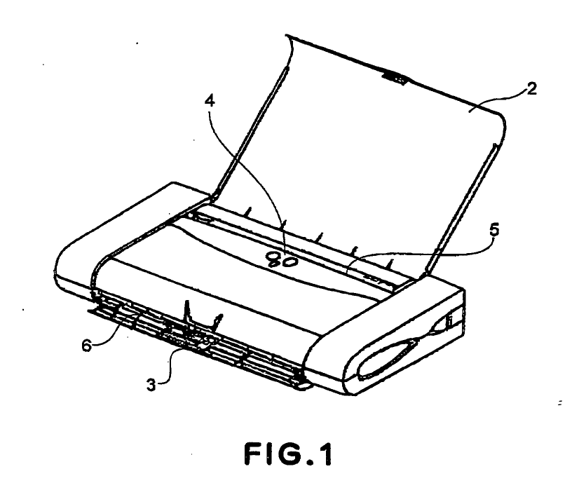

Referring to the accompanying drawings, the description will be made as to the preferred embodiments of the present invention. The same reference numerals are assigned to the elements having the corresponding functions throughout the drawings. FIG. 1 is a schematic perspective view of an outer appearance of an ink jet recording apparatus according to an embodiment of the present invention. In FIG. 1, designated by reference numeral 2 is a rotatable sheet feeding tray which also functions as a cover; 3 is a rotatable sheet discharge cover; 4 is an operation panel on which a main switch, a LED and the like are disposed; 5 is sheet feeding port for inserting a recording material such as a sheet; and 6 is a sheet discharge opening for permitting discharging of the recording material. When the recording device is not used, the sheet feeding tray 2 and the sheet discharge cover 3 are closed to protect the inside of the main assembly of the apparatus from foreign matter such as dust.

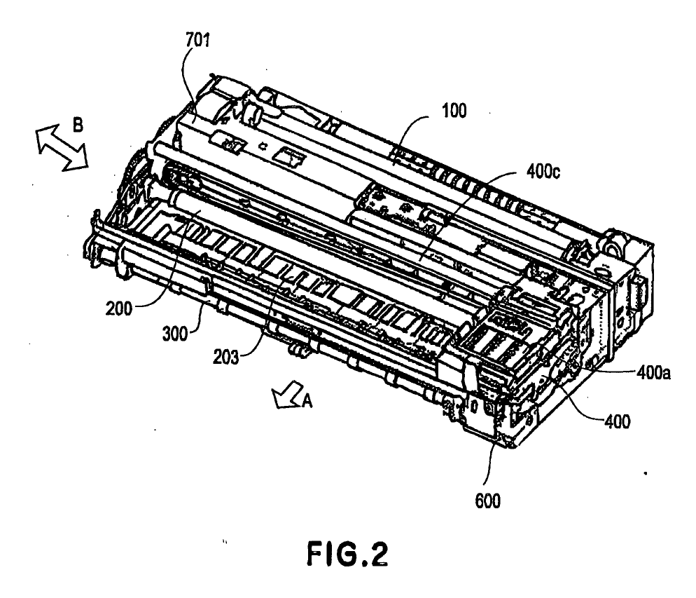

The present invention is a schematic perspective view of an inside structure of an ink jet recording apparatus according to the embodiment of the present invention. In FIG. 2, designated by reference numeral 100 is an automatic sheet feeder; 200 is a feeding portion; 300 is a sheet discharge portion; 400 is a recording portion (carriage portion); and 600 is a recovering mechanism portion. They are mounted on a chassis 701 or the like for proper interrelations among them. The automatic sheet feeder 100 functions to feed the recording material such as a sheet of paper, a plastic resin material sheet or another sheet material, one by one, into the main assembly of the apparatus. The feeding portion 200 functions to feed the recording material fed from the automatic sheet feeder 100 to the recording position and to feed the recording material on which the recording has been effected to the sheet discharge portion 300. The sheet discharge portion 300 functions to feed the recording material now having the record to the outside through the sheet discharge opening 6.

The recording portion 400 includes a carriage 400b carrying recording means 400a for effecting recording by ejecting the ink onto the recording material, and the carriage 400b is reciprocally supported and guided on a guiding shaft 400c. The recording means 400a is actuated in synchronism with the movement of the carriage 400b in response to the image information, by which a desired recording is effected on the recording material which is being fed through the recording by the feeding portion 200. The recovering mechanism portion 600 is provided with refreshing means for maintaining and recovering the ink ejection performance of the recording means 400a. At the position opposed to the reciprocal recording portion 400, there is provided a platen 203 for support and guiding the recording material through the recording portion.

In FIG. 2, an arrow A designates a feeding direction of the recording material, and an arrow B designates the reciprocal moving direction (main scan direction) of the recording portion 400. The illustrated ink jet recording apparatus has a thin type structure for mobile convenience, and has a thickness not more than approx. 60 mm in consideration of easy grip by hand which is approx. 70 mm-120 mm long. An office desk commercially available in European countries normally has a drawer with an inner size enough to accommodate letter size files, and therefore, with a dimension not less than 310 mm. In view of these facts, the ink jet recording apparatus shown in FIGS. 1 and 2 has a thickness of approx. 52 mm, a width of approx. 310 mm and a depth of approx. 174 mm, and therefore, it can be easily grasped by hand, and can be accommodated in a drawer of a desk. In the apparatus shown in FIGS. 1 and 2, the thickness is relatively small at the lateral side, the front side and the rear side, and among these side, the sheet discharge opening 6 is disposed at the front side.

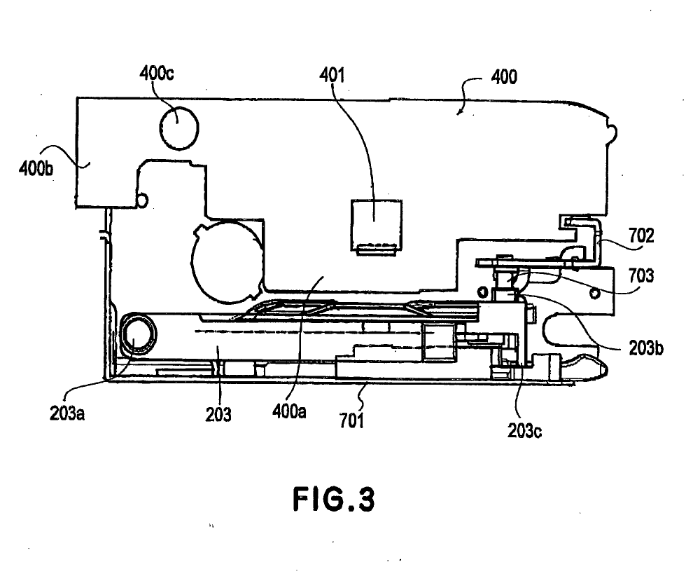

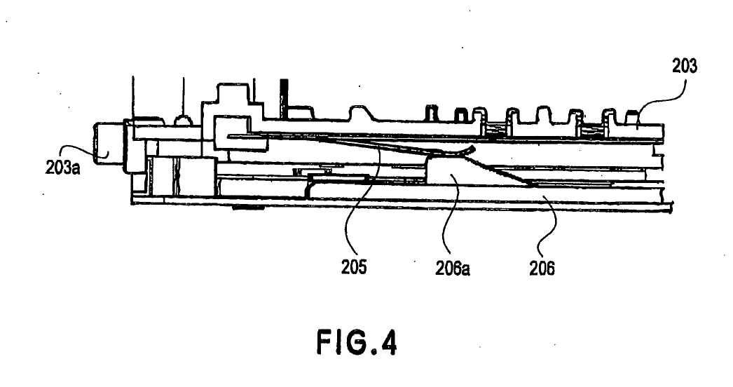

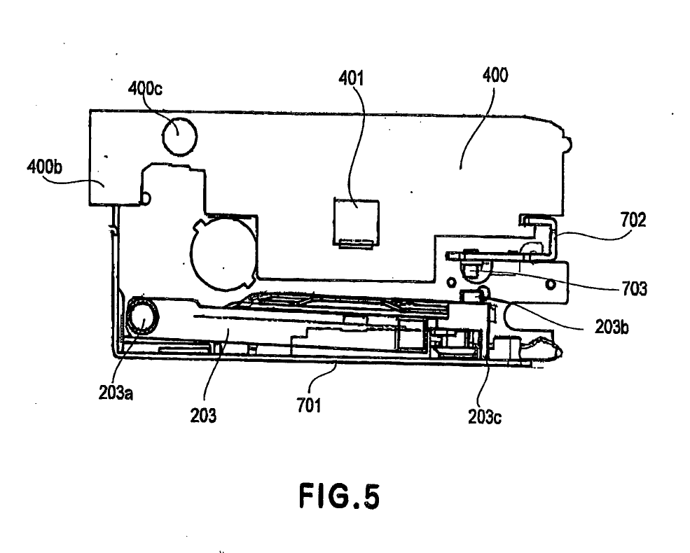

FIG. 3 is a schematic sectional side view illustrating a state of a head-platen distance switching mechanism when the recording is effected on a thin paper such as plain paper, in an ink jet recording apparatus according to an embodiment of the present invention. FIG. 4 is a schematic front view of a left (as seen from the front side) part of the head-platen distance switching mechanism used in the apparatus of FIG. 3. FIG. 5 is a schematic sectional side view of a state of the head-platen distance switching mechanism when the recording is effected on thick paper such as an envelope. FIG. 4 is a schematic front view of a left (as seen from the front side) part of the head-platen distance switching mechanism used in the apparatus of FIG. 5. Referring to FIG. 3-FIG. 6, the description will be made as to head-platen distance switching mechanism according to this embodiment. In FIG. 3-FIG. 6, the platen 203 disposed at a position opposed to the recording portion 400 in the recording region, is journaled on the chassis 701 for rotation about a center of rotation 203a, and by pivoting about the center of rotation 203a the gap between the recording means 400a and the platen 203 (head-platen distance) at the recording portion (carriage portion) 400 is changeable. The recording portion (carriage portion) 400 has a structure in which the recording means 400a is carried on the carriage 400b, wherein the carriage 400b is supported for sliding movement by the guiding shaft 400c and the guiding rail 702, so that carriage 400b is reciprocable.

When the recording is effected on thin paper such as plain paper (plain paper printing), the platen 203 is urged upwardly by a head-platen distance switching lever 206 which will be described hereinafter, by which a positioning portion 203b of the platen 203 is abutted to a free end of the adjustment screw 703 fixed on the chassis 701 so that vertical position of the platen 203 is regulated. More particularly, below the platen 203, there is provided a head-platen distance switching lever 206 (head-platen distance switching means) having a projected portion (contact portion) 206a, and the head-platen distance switching lever 206 is movable or slidable in the left-right direction. The bottom surface of the platen 203 has a leaf spring 205 mounted thereto. By moving the head-platen distance switching lever 206 toward the right hand side as seen from the front side of the recording device, the projected portion 206a urges the leaf spring 205 upwardly so as to urge the platen 203 upwardly to bring the positioning portion 203b to the adjustment screw 702, by which the vertical position of the platen 203 is determined. In this embodiment, the adjustment screw 702 is fixed on the guiding rail 702 which is provided on the chassis 701 to support and guide the carriage portion 400, but the vertical position of the adjustment screw 702 is adjustable.

In FIG. 3, at a proper position of the recording portion (carriage portion) 400 such as the carriage 400b or the recording means 400a, there is provided a recording positional deviation detecting means (registration adjustment sensor) 401 for detecting the recording positional deviation of the recording means (recording head) 400a. A predetermined pattern is printed by the recording means 400a, and the printed pattern is read by the registration adjustment sensor 401. On the basis of the read value, an adjustment value is calculated, and the ink ejection timing from the ejection outlet arrays of the recording means 400a is adjusted on the basis of the calculated adjustment value. By doing so, the registration adjustment (the adjustment of the recording positional deviation) is accomplished so that deterioration of the recording quality attributable to the recording positional deviation can be reduced.

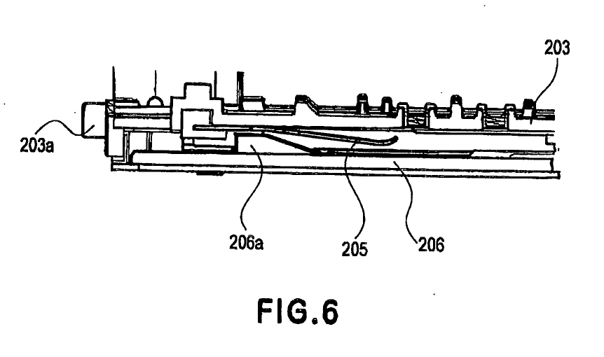

On the other hand, when the printing is made on thick paper such as an envelope (thick sheet printing), the head-platen distance switching lever 206 is moved to the left hand side as seen from the front side of the recording device. When the head-platen distance switching lever 206 moves to the left, the projected portion 206a of the head-platen distance switching lever 206, as shown in FIG. 6, is away from the leaf spring 205, and the platen 203 moves downwardly about the center of rotation 203a (lowers). When the platen 203 lowers until the position regulating portion 203c of the platen abuts the chassis 701, the vertical position of the platen is regulated. By the head-platen distance switching mechanism having been described in conjunction with FIG. 3-FIG. 6, the head-platen distance can be switched between for the thin paper such as plain paper (plain paper printing) and for the thickness paper such as an envelope.

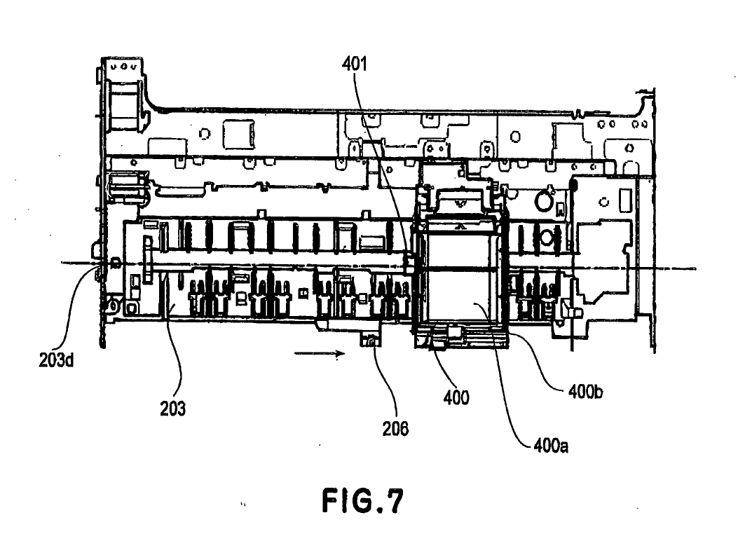

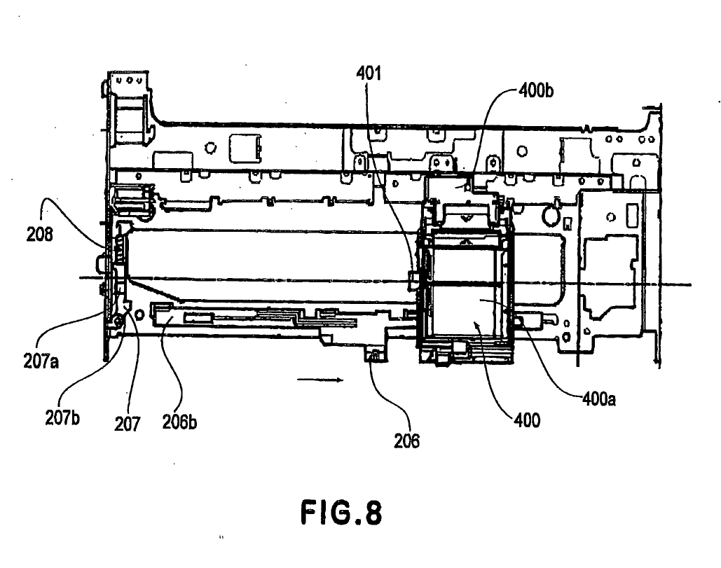

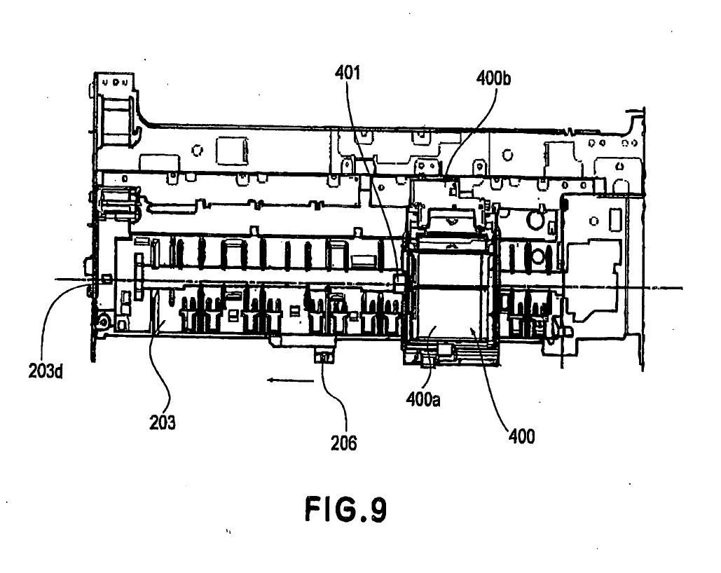

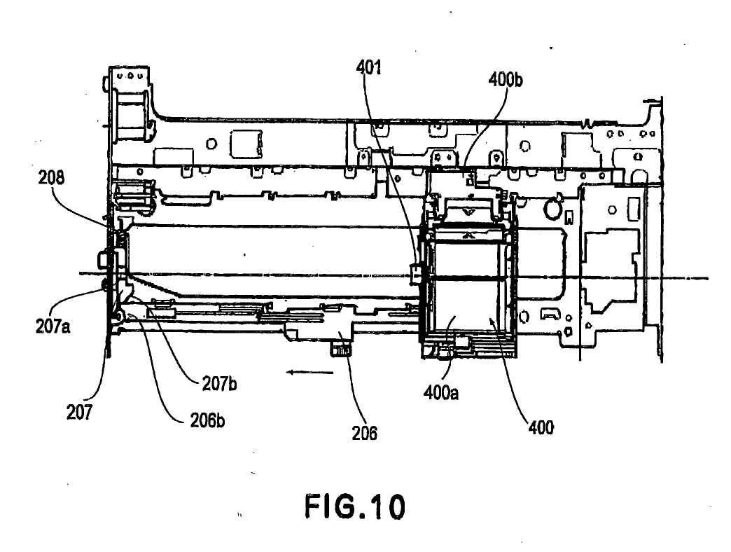

FIG. 7 is a schematic top plan view as seen from above the platen when the recording is effected on plain paper, in an ink jet recording apparatus according to an embodiment of the present invention. FIG. 8 is a schematic top plan view of a structure of a lower side by omitting the platen from FIG. 7. FIG. 9 is a schematic top plan view as seen from above the platen when the recording is effected on a thick sheet, according to an embodiment of the present invention. FIG. 10 is a schematic top plan view of a structure of a lower side by omitting the platen from FIG. 9. As shown in FIG. 7-FIG. 10, the platen 203 is provided at a predetermined left-hand end portion in the Figure with a detection hole (opening) 203d. The position of the detection hole 203d is disposed on the movement path (scanning path) of the registration adjustment sensor 401 provided in the recording portion 400 such that when the recording portion 400 moves to the left side, the registration adjustment sensor 401 is aligned with the detection hole 203d.

Below the detection hole 203d of the platen 203, there is provided a detecting lever 207. The detecting lever 207 is mounted for movement in a direction crossing with (normally perpendicular to) the moving direction of the (carriage portion) 400 and is urged by a compression spring 208 toward the downstream side (downwardly in the Figure) with respect to the feeding direction of the recording material. The detecting lever 207 has a glossy portion 207a which has a light reflection property which is higher than that of the other portions. The glossy portion 207a constitutes a portion to be detected of the registration adjustment sensor 401 (recording positional deviation detecting means). With such a structure, by moving the head-platen distance switching lever 206 to the left in the Figure, a contact portion 206b formed at the left free end of the head-platen distance switching lever 206 pushed up the inclined surface portion 207b of the detecting lever 207 so as to move the detecting lever 207 toward an upstream side with respect to the feeding direction of the recording material (upwardly in the Figure). By the upstream movement of the detecting lever 207, the glossy portion 207a, as shown in FIG. 10, to a position where it is opposed to right below the detection hole (opening) 203d of the platen 203.

The detection hole 203d is formed at a position above the movement path (scanning path) of the registration adjustment sensor 401 provided on the carriage portion 400, as described. Therefore, when the carriage 400b is driven to move the recording portion 400 to the left with the state of FIG. 10, that is, the state in which the glossy portion 207a is right below the detection hole 203d of the platen 203, the glossy portion 207a is detected at the position where registration adjustment sensor 401 of the recording portion 400 is aligned with and opposed to the detection hole 203d, by which it is detected that platen 203 is at the large head-platen distance position for the thickness sheet (FIGS. 5 and 6).

When the head-platen distance switching lever 206 is moved to the right hand side shown in FIGS. 4 and 7, the head-platen distance switching lever 206 is moved away from the detecting lever 207, as shown in FIG. 8 so that detecting lever 207 is moved toward the downstream with respect to the feeding direction of the recording material by the urging force of the compression spring 208, by which the glossy portion 207a is not exposed to the detection hole 203d of the platen 203 (offset and undetectable). Thus, even if the carriage portion 400 is moved to the left to align the registration adjustment sensor 401 with the detection hole 203d, the glossy portion 207a cannot be detected by the registration adjustment sensor 401. By detecting the undetectable state, it is discriminated that platen 203 is at the small head-platen distance position (FIGS. 3 and 4) for the plain paper printing. Thus, by utilizing the registration adjustment sensor 401 which has been functioned as the recording positional deviation detecting means, the head-platen distance positions (state of switching) can be detected.

According to this embodiment, therefore, when the head-platen distance is to be detected, the carriage 400b is moved so as to oppose the registration adjustment sensor 401 to the detection hole 203a of the platen 203, the state (position) of the detecting lever 207 is detected utilizing the registration adjustment sensor 401 which is the recording positional deviation detecting means. When it is detected that glossy portion 207a is right below the detection hole 203a, the head-platen distance is determined as being for the thick paper printing, and when the glossy portion 207a is not right below the detection hole 203a and therefore is not detected, the head-platen distance is determined as being for the plain paper printing. By such discrimination, the state of the head-platen distance switching of the platen 203 can be detected.

According to the embodiment of the present invention, there is provided an ink jet recording apparatus comprising a carriage for reciprocal movement while carrying recording means 400 for effecting recording by ejecting ink; a platen 203 for supporting the recording material at a position opposed to said recording means; a change member 206 for changing a distance between said recording means and said platen; a detecting member 401, provided on said carriage, for detecting recording positional deviation by reading a pattern recorded on a recording material by said recording means; a member to be detected movable with an operation of said changing member; and discriminating means for discriminating a distance between said recording means and said platen by detecting a state of said member to be detected by said detecting member. With such a structure, in an ink jet recording apparatus wherein the platen 203 is displaceable by the head-platen distance switching means 206 to switch the head-platen distance, head-platen distance, that is, the gap between the platen 203 and the recording means (the change of the gap) can be detected by utilizing the recording portion (carriage portion) 400 and the recording positional deviation detecting means (registration adjustment sensor) 401. Thus, the change of the head-platen distance (head-platen distance position) can be detected without upsizing the apparatus and without adding a sensor.

The present invention is applicable, with the similar advantageous effects, to a recording device using a single recording means, a color recording device using a plurality of recording means for effecting recording with different color inks, a tone gradation recording device using a plurality of recording means for effecting recording with the same color but different densities, and to a recording device combining them. The present invention is applicable, with the similar advantageous effects, to a structure using an exchangeable ink cartridge integrally having recording means and an ink container, to a structure using separate recording means and an ink container which are connected with each other by an ink supply tube, and to any other structures of the recording means and ink container. The present invention is suitably usable with the apparatus using recording means having electrical machine conversion member or the like such as piezoelectric elements or the like, but the present invention is particularly suitable to an ink jet recording apparatus using recording means of a type in which the ink is ejected using thermal energy. This is because the high density recording and the high precision recording are possible.

As described in the foregoing, according to the embodiments of the present invention, the head-platen distance can be detected utilizing the recording positional deviation means (registration adjustment sensor or the like), and therefore, the change in the head-platen distance can be detected with a small size and inexpensive structure without the necessity of adding a sensor.

While the invention has been described with reference to the structures disclosed herein, it is not confined to the details set forth and this application is intended to cover such modifications or changes as may come within the purpose of the improvements or the scope of the following claims.

This application claims priority from Japanese Patent Application No. 170878/2004 filed Jun. 9, 2004 which is hereby incorporated by reference.

1. An ink jet recording apparatus comprising:
a carriage for reciprocal movement while carrying recording means for effecting recording by ejecting ink;
a platen for supporting the recording material at a position opposed to said recording means;
a changing member for changing a distance between said recording means and said platen;
a detecting member, provided on said carriage, for detecting recording positional deviation by reading a pattern recorded on a recording material by said recording means;
a member to be detected movable with an operation of said changing member; and
discriminating means for discriminating a distance between said recording means and said platen by detecting a state of said member to be detected by said detecting member.

2. An apparatus according to claim 1, wherein said platen moves relative to said recording means with the operation of said changing member.

3. An apparatus according to claim 2, wherein said platen is rotatable relative to a main assembly of said apparatus.

4. An apparatus according to claim 1, further comprising an opening at a position of said platen opposed to a movement path of said carriage, said detecting member detects the state of said member to be detected through the opening.

5. An apparatus according to claim 1, wherein said changing member includes a lever disposed at a front side of said apparatus.
